(19) United States
(12) Patent Application Publication
(10) Pub. No.: US 2014/0090466 A1
(43) Pub. Date: Apr. 3, 2014

(54) FUEL SENSING SYSTEM AND METHOD OF OPERATION

(71) Applicant: Delta Systems, Inc., Streetsboro, OH (US)

(72) Inventor: Nicholas Schragal, Chardon, OH (US)

(73) Assignee: Delta Systems, Inc., Streetsboro, OH (US)

(21) Appl. No.: 14/039,048

(22) Filed: Sep. 27, 2013

Related U.S. Application Data
(60) Provisional application No. 61/707,149, filed on Sep. 28, 2012.

(51) Int. Cl. G01F 23/44

(52) U.S. Cl. CPC G01F 23/443
USPC 73/313

(57) ABSTRACT

A fuel sensing system and method of measuring and monitoring an amount of fuel in a storage tank for power operated equipment. The method comprises the steps of positioning a fuel sensor assembly within a storage tank that supports fuel provided to the power operated equipment during operation and generating a pulse width modulated output signal with a pulse width modulation generating circuit. The pulse width modulated output signal provides a signal width proportional to the fuel level in the storage tank. The method also comprises processing the pulse with modulated output signal with non-transient computer readable medium by one or more processors internal to a microcontroller to form an output value indicating the amount of fuel in the storage tank and displaying the output value on an indicator display mounted on the power equipment.

### CROSS REFERENCES TO RELATED APPLICATIONS

The following application is a Nonprovisional patent application that claims priority to co-pending U.S. Provisional Patent Application Ser. No. 61/707,149 filed Sep. 28, 2012 entitled FUEL SENSING SYSTEM AND METHOD OF OPERATION. The above-identified application is incorporated herein by reference in its entirety for all purposes.

### TECHNICAL FIELD

The present disclosure relates to a fuel sensing system and method of operation, and more particularly, a fuel sensing system and process for monitoring fuel levels in outdoor power equipment.

### BACKGROUND

Fuel sensors coupled to indicator displays or fuel gauges are frequently used in outdoor power equipment. Outdoor power equipment includes, but is not limited to, riding lawn mowers, lawn and agricultural tractors, snowmobiles, snowblowers, jet skis, boats, all terrain vehicles, bulldozers, generators, and the like. Fuel sensors indicate to the operator of the power equipment how much fuel remains in the fuel supply or tank.

The fuel sensors indicator displays in a riding mower or tractor is frequently mounted to the dash panel, typically in view with the operator while operating the lawn mower. Further discussion relating to developments in indicator displays are discussed in U.S. Pat. No. 7,777,639 that issued on Aug. 17, 2010. The '639 patent is owned by the assignee of the present application and is incorporated herein by reference in their entirety.

### SUMMARY

One example embodiment of the present disclosure includes a fuel sensing system and method of measuring and monitoring an amount of fuel in a storage tank for power operated equipment. The method comprises the steps of positioning a fuel sensor assembly within a storage tank that supports fuel provided to the power operated equipment during operation and generating a pulse width modulated output signal with a pulse width modulation generating circuit. The pulse width modulated output signal provides a signal width proportional to the fuel level in the storage tank. The method also comprises processing the pulse with modulated output signal with non-transient computer readable medium by one or more processors internal to a microcontroller to form an output value indicating the amount of fuel in the storage tank and displaying the output value on an indicator display mounted on the power equipment.

Another example embodiment of the present disclosure includes a system measuring and monitoring an amount of fuel in a storage tank for power operated equipment comprising a control circuit having a non-transitory computer readable medium storing machine executable instructions executable by a processor coupled to and in communication with the control circuit for reading and processing a pulse width modulated signal to form a non-transitory output value indicating the amount of fuel in a storage tank. The system further comprises a display for displaying the non-transitory output value for viewing by a user of the system.

While another example embodiment of the present disclosure includes an apparatus for measuring and monitoring an amount of fuel in a storage tank comprising a fuel sensor assembly to be positioned during use within a storage tank that supports fuel provided to power operated equipment during operation, the fuel sensor assembly having a pulse width modulation circuit for generating a pulse width modulated signal wherein the pulse width modulated signal has a signal width proportional to the fuel level in a storage tank and a control circuit remotely located from fuel sensor assembly, the control circuit having a non-transitory computer readable medium storing machine executable instructions executable by a processor coupled to and in communication with said control circuit for reading said pulse width modulated signal to form a non-transitory output value indicating the amount of fuel in a storage tank.

### BRIEF DESCRIPTION OF THE DRAWINGS

The foregoing and other features and advantages of the present disclosure will become apparent to one skilled in the art to which the present invention relates upon consideration of the following description of the invention with reference to the accompanying drawings, wherein like reference numerals refer to like parts unless described otherwise throughout the drawings and in which:

FIG. 1 illustrates one form of power equipment using a fuel sensing system in accordance with one example embodiment of the present disclosure;

FIG. 2 illustrates a fuel sensing gauge used with the fuel sensing system in accordance with one example embodiment of the present disclosure;

FIG. 3 illustrates a fuel sensor assembly constructed in accordance with one example embodiment of the present disclosure;

FIG. 4 illustrates a signal profile analyzed in a fuel sensing system in accordance with one example embodiment of the present disclosure;

FIG. 5 is a first portion of an electrical schematic of a fuel sensing system in accordance with one example embodiment of the present disclosure;

FIG. 6 is a second portion of the electrical schematic of FIG. 5;

FIG. 7 is a block diagram illustrating the operation of a fuel sensing system in accordance with one example embodiment of the present disclosure; and

FIG. 8 is a block diagram illustrating the operation of an anti-slosh process of a fuel sensing system in accordance with one example embodiment of the present disclosure.

### DETAILED DESCRIPTION

Referring now to the figures generally wherein like numbered features shown therein refer to like elements throughout unless otherwise noted. The present disclosure relates to a fuel sensing system and method of operation, and more particularly, a fuel sensing system and process for monitoring fuel level in outdoor power equipment with heightened accuracy.

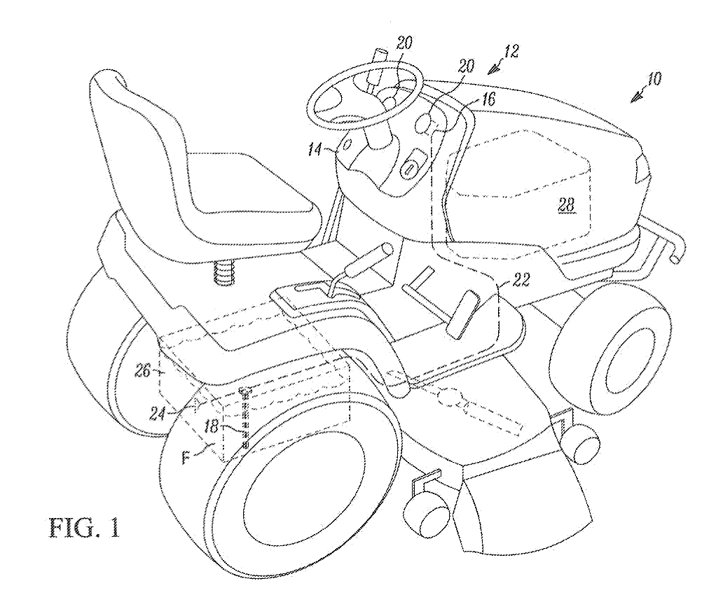

FIG. 1 illustrates power equipment 10 in the form of a riding mower. The power equipment 10 employs a fuel sensing system 12 constructed in accordance with one example embodiment of the present disclosure. It should be appreciated by those skilled in the art, that the power equipment 10 in addition to being a riding mower, could also be lawn and agricultural tractors, snowmobiles, snowblowers, jet skis, boats, all terrain vehicles, bulldozers, generators, and the like without departing from the spirit and scope of the present disclosure.

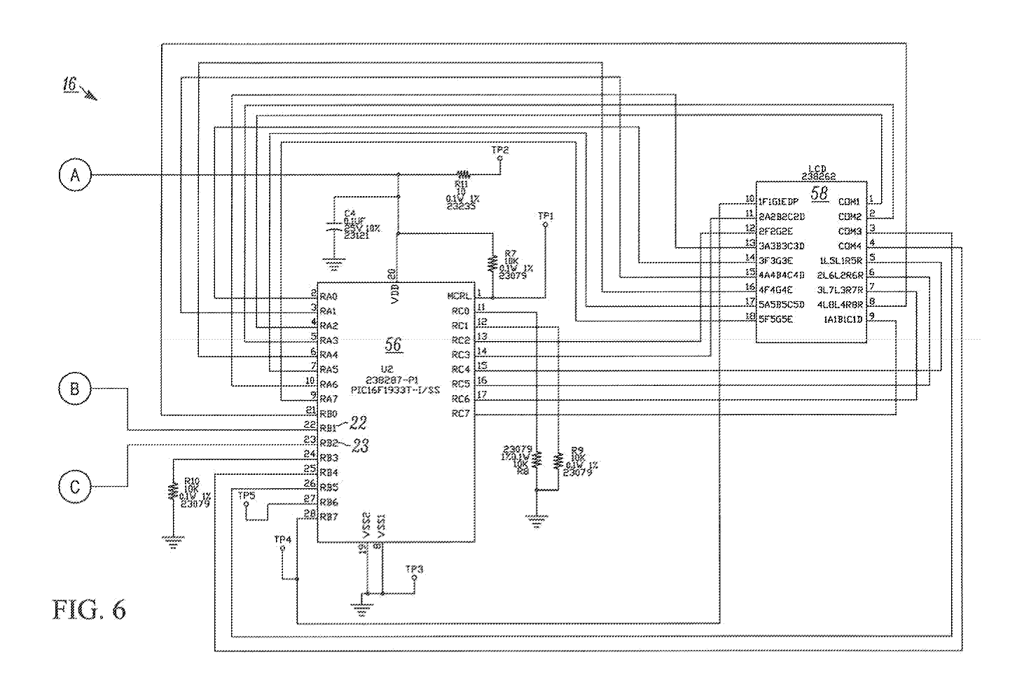

As stated above, the power equipment 10 uses a fuel sensing system 12 that comprises an indicator display 20, located typically on the dash 14 of the riding mower as illustrated in FIG. 1. The fuel sensing system 12 further comprises a control circuit 16 (see FIGS. 5 and 6), and fuel sensor assembly 18 (see FIG. 3). The fuel sensor assembly IS8 is in communication with the control circuit 16 either directly by hard wire 22 or by wireless communication 24 such as Wi-Fi, Bluetooth, or other known over-the-air protocols.

As illustrated in FIG. 1, the fuel sensor assembly 18 is located in a fuel tank 26 that stores liquid fuel such as gasoline or diesel for powering an internal combustion engine 28 of the power equipment 10. The fuel sensor assembly 18 is further shown in more detail in FIG. 3, and comprises a sensor 30 having a body 32 and a cylindrical stem portion 34 that is partially surrounded by a float 38. Internal to the stem portion 34 is a detector 36 that includes a magnetic relationship with the float 38. That is, either the detector 36 or float 38 includes a magnetic component that communicates a level sensing signal 42 to the control circuit 16 that can be located in the body 32 or as in the illustrated example embodiment, on the indicator display 20, or both.

The float 38 moves up and down the stem 34 in the directions of arrows A as the level of the fuel (F) moves up and down in the tank 26, indicated by arrows B. As the float 38 moves up and down the stem 34, supply power 40 from, for example, a battery passing through a voltage regulator (not shown) provides a direct current DC signal 42A, in which the signal's magnitude is altered magnetically based on the location of the float corresponding to the fuel level within the tank. Thus, the magnitude of the DC signal 42A is proportional to the level of the fuel in the tank 26 of the power equipment 10.

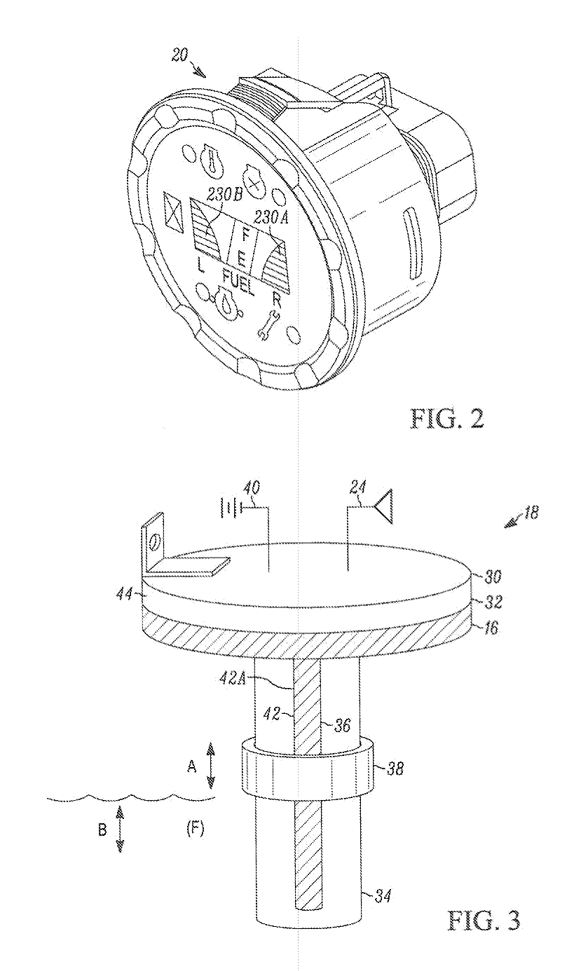

While FIG. 3 illustrates a single fuel sensor assembly 18, it should be appreciated by those skilled in the art that any number of fuel sensor assemblies could be used in the fuel sensing system 12. In fact, the control circuit 16 in the illustrated example embodiments of FIGS. 5 and 6 is constructed to receive and supply power to two separate fuel sensor assemblies 18, for left and right tanks as indicated in the display 20 of FIG. 2.

Unlike conventional fuel sensors that use an analog signal from a rotary potentiometer to generate a signal as an indication the fuel level in the tank, the fuel sensor assembly 18 includes a pulse width modulator circuit 44. The PWM circuit 44, in one example embodiment includes a PWM signal generator constructed from an analog circuit, a digital circuit, a discrete integrated circuit IC, microcontroller, or any combination thereof as would be appreciated by those skilled in the art.

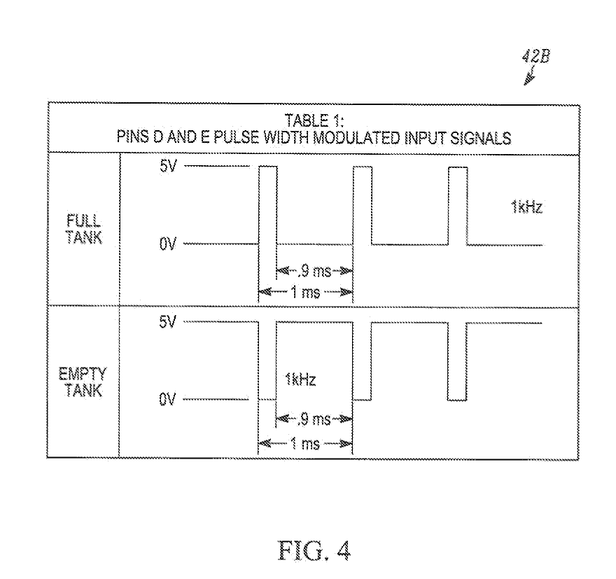

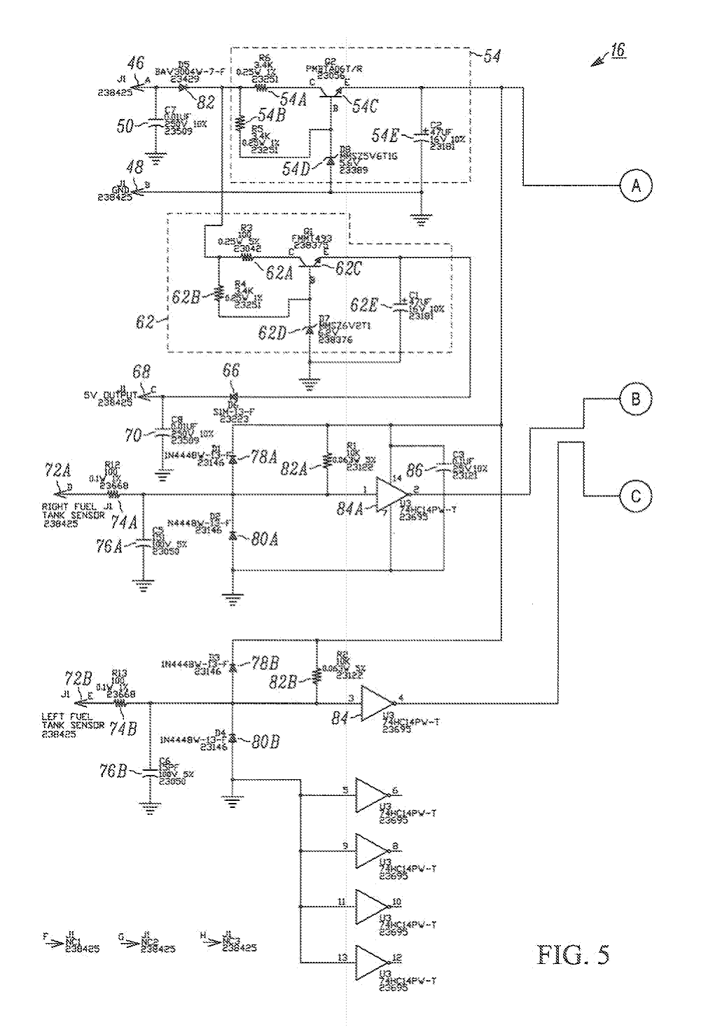

The PWM circuit 44 alters the DC signal 42A to a PWM signal 42B shown in FIG. 4. The PWM signal 42B forming the sensing signal 42, which because the signal is pulse width modulated, has superior noise immunity over conventional analog signals. Thus, noise generated by the power equipment 10 is minimized, increasing the accuracy of the fuel sensing system 12. For example, a conventional analog signal used in interfacing a fuel sensor to a fuel gauge uses an analog signal that may vary from 0.5 VDC to 4.5 VDC. When the sensor signal is 0.5 VDC, this indicates that the tank fuel level is out empty. When the sensor signal is 4.5 VDC, this indicates that fuel tank is full. A typical method of reading this conventional DC signal is via a microcontroller with an A/D converter. The A/D converter would typically be an 8-bit converter and as such, possess a resolution of 5V/256 counts, which equals 0.0195V/count. Therefore, an 8-bit A/D converter in the microcontroller requires only 0.0195V of signal change before it changes the output value.

If noise or wiring in the power equipment 10 induces in this conventional system 0.0195V of signal onto an existing half full tank signal of 2.5 VDC, a new signal of 2.5195V is received. This error by the count amount of 0.0195V represents a different and inaccurate fuel level to the sensing and display system of the power equipment.

Advantageously, the PWM signal 42B of the present disclosure generated by PWM circuit 44 as part of the fuel sensor assembly 18 and shown in FIG. 4 provides a more accurate signal representative of fuel levels as it is communicated to the control circuit 16. In the illustrated example PWM signals 42B embodiments of FIG. 4, the PWM signal 42B employs the varying low pulse width from 0.1 mS low for empty to 0.9 mS low for a full tank. In order for noise to affect this 5V PWM signal, it must be approximately 5V in amplitude, or 5V/0.0195V, which equals 256 times larger amplitude noise than what would erroneously influence a conventional analog signal. Advantageously, the PWM signal 42B allows for increased distances between the fuel sensor assembly 18 and the control circuit 16 because of the reduced influence of noise on the fuel level being measured.

Referring now to FIGS. 5 and 6 are schematics forming the control circuit 16 constructed in accordance with one example embodiment of the present disclosure. The control circuit 16 receives and processes the PWM signal 42B communicated via wiring harness or over-the-air from the PWM generator circuit 44.

Input power to the control circuit 16 is supplied by connector pin 46 and ground by connector pin 48. Capacitor 50 filters power from any noise or transients exposed to the circuit 16. The control circuit 16 employs a rectifier 52 that provides reverse polarity protection for the incoming power supply. In one example embodiment, the power supply is a 12V DC battery.

The control circuit 16 further comprises a voltage regulator circuit 54 consisting of resistors 54A and 54B, transistor 54C, zener diode 54D and capacitor 54E. The voltage regulator circuit 54 provides power to integrated circuits 56, 58. Resistor 54A is a current limiting resistor that protects transistor 54C in case of a short to ground occurs. Resistor 54B supplies zener current to zener diode 54D. The zener diode 54D supplies 5.6V to transistor 54C. In the voltage regulator circuit 54, the emitter lead of transistor 54C is regulated at approximately 5 VDC. A capacitor 54E acts as an output filter for 5V load transients.

An additional voltage regulator circuit 62 consists of resistors 62A and 62B, transistor 62C, zener diode 62D, and capacitor 62E. The voltage regulator circuit 62 provides power to two remote fuel sensor assemblies 18. Resistor 62A is a current limiting resistor that protects transistor 62C in case of a short to ground occurs. Resistor 62B supplies zener current to zener diode 62D. The zener diode 62D supplies 6.2V to the transistor 62C. In the voltage regulator circuit 62, the emitter lead of transistor 62C is regulated at approximately 5 VDC. The capacitor 62E acts as an output filter for 5V load transients of the fuel sensor assemblies 18.

A diode 66 provides reverse polarity protection for the output 5 VDC at connector 68. A capacitor 70 provides a high frequency filter for output 68.

The fuel sensor assembly 18 and particularly the PWM circuit 44, for a left “L” and right “R” fuel tank receive their respective supply power from output 68 as illustrated in the example embodiment of FIG. 2. Of course, it should be appreciated that one or more fuel tanks 26 or divisions within a single tank requiring one or more fuel sensor assemblies 18 is intended to be within the scope of the claims of the present disclosure.

The PWM signal 42B of FIG. 4 from each fuel sensor assembly 18 is communicated from respective fuel sensor assembly to input 72A for the right fuel tank and input 72B for the left fuel tank. As illustrated in the example embodiment of FIG. 4, the width of the pulse from the fuel tank sensor assembly 18 is proportional to the level of the fuel in the tank. In the illustrated example embodiment, the empty tank signal is low for 0.1 mS and high for 0.9 mS as illustrated in FIG. 4. A full tank signal in FIG. 4 is low for 0.9 mS and high for 0.1 mS.

A low-pass filter is formed with resistor 74 and capacitor 76 for the PWM signal 42B. Diode 78 provides a clamp to 5 VDC for the PWM signal 42B. Diode 80 provides a clamp to ground for the PWM signal 42B. Resistor 82 is a pull-up resister for the PWM generator 44 and provides current to an internal output transistor of the generator. A Schmitt trigger inverter 84 reduces the noise influence on the measurement of the PWM 42B signal at pins 1 and 2 in the right fuel tank circuit at pins 3 and 4 in the left fuel tank. Capacitor 86 is a noise decoupling capacitor for the Schmitt trigger inverter 84A. Output pin 2 of Schmitt trigger 84A is the input into microcontroller 56 at pin 22 for measurement and averaging of the PWM signal 42B. Output pin 3 of the Schmitt trigger 84B is the input to the microcontroller 56 at pin 23 for measurement and averaging of the PWM signal 42B.

In the illustrated example embodiment, microcontroller 56 is a PIC chip. In particular, the PIC chip is identified under part number 16F1933T, which the specification data sheet is incorporated herein by reference. The microcontroller 56 measures the pulse width and period of the pulse width modulated signal 42B at input pins 22 and 23 for respective left L and right R tanks having respective fuel sensor assemblies 18. The measurement by the microcontroller 56 of the PWM signal 42B of both the width and period are then translated to percent duty cycle via a formula represented by percentage duty cycle is equal to the pulse width divided by the period. The percentage duty cycle that is then translated for display by illuminating the corresponding bars of the LCD in the gage 20 for respective tanks as illustrated in FIG. 2.

The microcontroller 56 includes one or more processors, such as one or more microprocessors, digital signal processors (DSPs), combinations thereof or such other devices known to those having ordinary skill in the art. Each processor is coupled to an at least one memory device (also referred to herein as “a memory”), such as random access memory (RAM), dynamic random access memory (DRAM), and/or read only memory (ROM) or equivalents thereof, that maintains data and programs/instructions that may be executed by the one or more processors. Unless otherwise specified herein, all functions described as being performed herein by the microcontroller 56 is performed by their respective one or more processors, which are configured to perform such functionality based on the data and programs/instructions maintained in the corresponding memory.

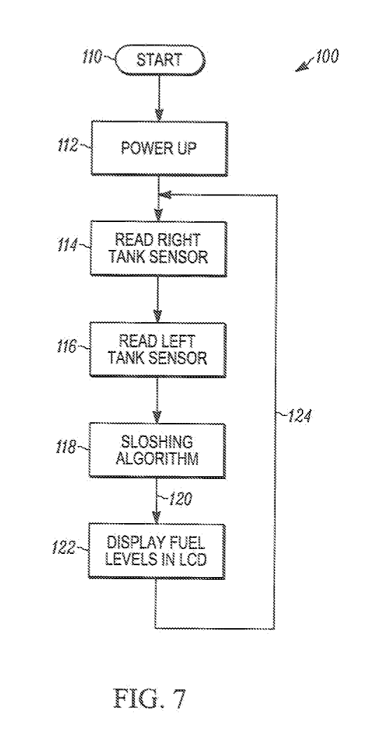

Illustrated in FIG. 7 is a block diagram illustrating an operation 100 of a fuel sensing system 12 in accordance with one example embodiment of the present disclosure. The operation 100 is initiated at 110, typically by the actuation of the power equipment motor or starter by engaging, for example a push button or turning of a key in an ignition. At 112, the operation 100 is powered up by a power supply such as a 12 VDC battery. At 114 and 116, right and left tank sensors are read by microcontroller 56. It should be appreciated that only one or multiple fuel sensor assemblies 18 can be used in multiple or single fuel tanks 26. At 118, a sloshing algorithm is executed by processors internal to microcontroller 56. The sloshing algorithm 118 uses the PWM signal 42B as an input from which an output 120 is calculated relating to the level of fuel in the tank. At 122, a display provided for example in LCD of gage 20 as to the fuel levels in the tank or tanks. At 124, the operation 100 is repeated after power up so that the fuel levels are monitored continuously during operation of the power equipment 10.

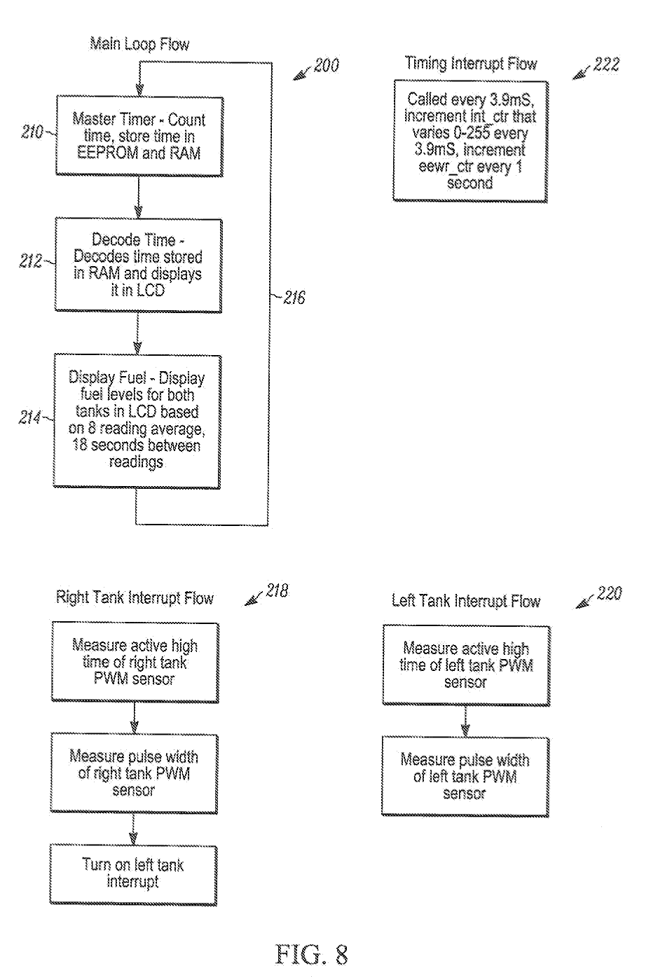

Illustrated in FIG. 8 is a block diagram illustrating the operation 200 of an anti-slosh process for a fuel sensing system 12 in accordance with one example embodiment of the present disclosure. The operation 200 in one example embodiment is in the form of software or firmware having executable non-transient readable media instructions executed by the processors located within microcontroller 56.

The main loop of the operation 200 shown in FIG. 8 identifies three blocks of execution, namely executed operations 210, 212, and 214. The operation 200, and specifically operations 210, 212, 214 and interrupts 218, 220, and 222 in one example embodiment continuously ping and/or analyze PWM signal 42B during the loop 124 of the fuel sensing operation of FIG. 7.

At 210, a master timer used to count time and/or store time associated with the PWM signal 42B in EEPROM and RAM. At 212, the time from the PWM signal 42 is decoded, by for example an A/D converter internal to the microcontroller 56 stored in RAM.

At 214, the microcontroller 56 reads eight (8) separate signals from the PWM generator from the fuel sensor assemblies 18. Each reading is collected by the microcontroller 56 at an average rate of 1 reading or PWM 42B signal every 18 seconds. These eight (8) readings are then averaged by processors internal to the microcontroller 56 to create a final value 230A/230B, relating to fuel level for each fuel sensor assembly 18 for display on the liquid crystal display (LCD) as shown in FIG. 2 on gage 20. At 216, a loop continues by returning to the operation 200 at 210.

The fuel tank 26 level readings used by the main loop 210-216 are generated by two separate interrupt routines, 218 and 220. Each interrupt routine waits for the sensor 18 value to go high in the PWM signal 42B, and then processors within the microcontroller 56 measure the amount of time it is high for the width measurement. Then the interrupts 218 and 220 wait until the sensor 18 value of the PWM signal 42B goes high again to generate the period measurement. With these two measurements, relating to time and period, the operation 200 computes the pulse width value based on the following formula PWM value=pulse width/pulse period written as instructions from software or firmware forming the operation 200 internal to the microcontroller 56.

This operation 200 also indicates to the operator that a fuel sensor assembly 18 is not connected by detecting the loss of the PWM signal 42B. Upon loss of signal 42B, blinking occurs in corresponding left or right tank bars. This is useful for troubleshooting and for the operator to ensure the system is working properly.

When the fuel gauge 20 powers up, a power up routine, which measures each fuel tank eight (8) times to fill up the running average buffer, as indicated by the timing interrupt 222. The timing interrupt permits the operator to fill up the tank and not have to wait for 8×18 seconds, or 144 seconds before indicating the value of the fuel level.

What have been described above are examples of the present disclosure. It is, of course, not possible to describe every conceivable combination of components or methodologies for purposes of describing the present disclosure, but one of ordinary skill in the art will recognize that many further combinations and permutations of the present disclosure are possible. Accordingly, the present disclosure is intended to embrace all such alterations, modifications, and variations that fall within the spirit and scope of the appended claims.

What is claimed is:

1. A method of measuring and monitoring an amount of fuel in a storage tank for power operated equipment, the method comprising the steps of:
positioning a fuel sensor assembly within a storage tank that supports fuel provided to the power operated equipment during operation;
generating a pulse width modulated output signal with a pulse width modulation generating circuit, the pulse width modulated output signal providing a signal width proportional to the fuel level in the storage tank;
processing said pulse width modulated output signal with non-transient computer readable medium by a processor internal to a microcontroller to form an output value indicating the amount of fuel in said storage tank; and
displaying said output value on an indicator display mounted on said power equipment.

2. The method of measuring and monitoring an amount of fuel in a storage tank of claim 1 wherein said step of processing said pulse with modulated output signal with non-transient computer readable medium by a processor internal to a microcontroller to form an output value further comprises the step of dividing the pulse width of the pulse modulated output signal with the period of the pulse width modulated output signal.

3. The method of measuring and monitoring an amount of fuel in a storage tank of claim 1 further comprising the step of refining said pulse width modulated output signal to a refined pulse width modulated output signal by processing an anti-sloshing algorithm by said processor internal to said microcontroller and using said refined pulse width modulated output signal as said output value indicating the amount of fuel in said storage tank.

4. The method of measuring and monitoring an amount of fuel in a storage tank of claim 1 wherein the step of processing said pulse width modulated output signal with non-transient computer readable medium by a processor internal to a microcontroller to form an output value indicating the amount of fuel in said storage tank is achieved by a plurality of processors internal to said microcontroller.

5. The method of measuring and monitoring an amount of fuel in a storage tank of claim 1 wherein the step of processing said pulse width modulated output signal with non-transient computer readable medium by a processor internal to a microcontroller to form an output value indicating the amount of fuel in said storage tank is achieved by a plurality of processors external to said microcontroller.

6. The method of measuring and monitoring an amount of fuel in a storage tank of claim 3 wherein the step of refining said pulse width modulated output signal to a refined pulse width modulated output signal by processing an anti-sloshing algorithm by said processor internal to said microcontroller further comprises averaging several of said pulse width modulated output signals with said processor internal to said microcontroller to obtain said refined pulse width modulated output signal and using said refined pulse width modulated output signal as said output value indicating the amount of fuel in said storage tank.

7. A system measuring and monitoring an amount of fuel in a storage tank for power operated equipment comprising:
a control circuit having a non-transitory computer readable medium storing machine executable instructions executable by a processor coupled to and in communication with said control circuit for reading and processing a pulse width modulated signal to form a non-transitory output value indicating the amount of fuel in a storage tank; and
a display for displaying said non-transitory output value for viewing by a user of the system.

8. The system of claim 7 further comprising a fuel sensor assembly to be positioned during use within a storage tank that supports fuel provided to power operated equipment during operation, the fuel sensor assembly having a pulse width modulation circuit for generating said pulse width modulated signal wherein the pulse width modulated signal has a signal width proportional to the fuel level in a storage tank.

9. The system of claim 7 wherein said non-transitory output value comprises the pulse of the pulse width modulated signal divided by the period of the pulse width modulated signal.

10. The system of claim 8 wherein said non-transitory output value comprises the pulse of the pulse width modulated signal divided by the period of the pulse width modulated signal.

11. The system of claim 8 wherein said fuel sensor assembly is remotely located from said control circuit.

12. The system of claim 11 wherein said system further comprises a lawn tractor having a fuel tank wherein said fuel sensor assembly is positioned within said fuel tank.

13. The system of claim 12 wherein said display is located on a dash panel of said lawn tractor.

14. An apparatus for measuring and monitoring an amount of fuel in a storage tank comprising:
a fuel sensor assembly to be positioned during use within a storage tank that supports fuel provided to power operated equipment during operation, the fuel sensor assembly having a pulse width modulation circuit for generating a pulse width modulated signal wherein the pulse width modulated signal has a signal width proportional to the fuel level in a storage tank; and
a control circuit remotely located from fuel sensor assembly, the control circuit having a non-transitory computer readable medium storing machine executable instructions executable by a processor coupled to and in communication with said control circuit for reading said pulse width modulated signal to form a non-transitory output value indicating the amount of fuel in a storage tank.

15. The apparatus of claim 14 further comprising a display for displaying said non-transitory output value.

16. The apparatus of claim 14 wherein said pulse width modulated circuit comprises any combination of analog circuit, digital circuit, discrete integrated circuit, or microcontroller.

17. The apparatus of claim 14 wherein said pulse width modulated circuit communicates said pulse width modulated signal to said control circuit through a wireless protocol.

18. The apparatus of claim 14 wherein said pulse width modulated circuit communicates said pulse width modulated signal to said control circuit through a hard wired connection.

19. The apparatus of claim 17 wherein said wireless protocol comprises any one of Wi-Fi, Bluetooth and cloud communication protocols.

20. The apparatus of claim 14 wherein said non-transitory output value comprises the pulse of the pulse width modulated signal divided by the period of the pulse width modulated signal.
